(19) United States
(12) Patent Application Publication
(10) Pub. No.: US 2004/0242233 A1
(43) Pub. Date: Dec. 2, 2004

(54) Method and system for providing a mobile node proxy service to a traveling mobile node

(75) Inventor: Craig Lutgen, Richardson, TX (US)

Correspondence Address: DUANE MORRIS, LLP, IP DEPARTMENT, ONE LIBERTY PLACE, PHILADELPHIA, PA, 19103-7396, US

(73) Assignee: Navini Networks, Inc., Richardson, TX

(21) Appl. No.: 10/453,809

(22) Filed: Jun. 2, 2003

(51) Int. Cl. H04Q 7/20

(52) U.S. Cl. 455/445; 455/422.1

(57) ABSTRACT

A method and system for servicing a mobile node by a proxy when it joins a foreign network is disclosed. When the mobile node connects to a first point-of-attachment in the foreign network, the foreign network detects the existence of this mobile node. Then, a first mobile node proxy is established that is in communication with the foreign network. The proxy acquires the home network based IP address associated with the mobile node and IP addresss associated with a mobile agent servicing the mobile node through the proxy pretending that the proxy is the mobile node. On behalf of the mobile node, the proxy establishes a communication route between the mobile node proxy to the home network through the foreign network using the acquired IP addresses. As such, the proxy shields the mobile node from conducting at least one control signaling process when the mobile node joins the foreign network so as to eliminate the need for the mobile node to be cognizant of the control signaling process, thereby further eliminating the need for the mobile node to consume resources for participating in the control signaling process.

### BACKGROUND

As mobile computing becomes more popular, computing devices or hosts have become more and more physically detached from a fixed home network while demanding continuous connectivity to it. For example, a user carrying a laptop from his home to his office may prefer to continually use the network such that he can be mobile. The need for a host to maintain one network layer IP address, regardless of point-of-attachment to the network/Internet, has resulted in the issuance of the Mobile Internet Protocol (Mobile IP) for mobile communications by the Internet Engineering Task Force as RFC3220.

In order to allow a mobile user moves from one wireless communication subnet/network to another without having his or her communication disrupted, a data routing problem has to be addressed. The Mobile IP provides such a solution for delivering datagrams/packets to an IP address that is “topologically incorrect” for the subnet point-of-attachment. If a mobile user's IP address belongs to the subnet/network that the mobile user is connected to through a point-of-attachment (or, the mobile user is in his or her home network), then it is deemed as “topologically correct” and the datagrams flow in to and out from the mobile user's computing device as usual. When the mobile user uses an IP address that does not belong to the subnet/network that he or she attaches his or her mobile computing device to (in another word, it is in a foreign network), then the IP address is rather odd comparing to other IP addresses used in the subnet/network, and it is then “topologically incorrect.” For the purpose of this disclosure, the computing device/platform/host that the mobile user uses for carrying out mobile communications is referred to as a mobile node and is consistent with the definition for the Mobile Node according to the Mobile IP.

What is needed is an efficient method and system for the mobile node to connect to any non-home based subnet/network with as little messaging overhead as possible.

### SUMMARY

A method and system for servicing a mobile node by a proxy when it joins a foreign network is disclosed. When away from its home network, the mobile node intends to connect to the home network through the foreign network so that datagrams can be continuously received or sent by the mobile node using a stable home network based IP address. A method and system for servicing a mobile node by a proxy when it joins a foreign network is disclosed. When the mobile node connects to a first point-of-attachment in the foreign network, the foreign network detects the existence of this mobile node. Then, a first mobile node proxy is established that is in communication with the foreign network. The proxy acquires the home network based IP address associated with the mobile node and IP addresss associated with a mobile agent servicing the mobile node through the proxy pretending that the proxy is the mobile node. On behalf of the mobile node, the proxy establishes a communication route between the mobile node proxy to the home network through the foreign network using the acquired IP addresses. As such, the proxy shields the mobile node from conducting at least one control signaling process when the mobile node joins the foreign network so as to eliminate the need for the mobile node to be cognizant of the control signaling process, thereby further eliminating the need for the mobile node to consume resources for participating in the control signaling process.

### BRIEF DISCUSSION OF THE DRAWINGS

FIG. 1 illustrates a sample schematic for a communication network

FIG. 2 illustrates another schematic of a large scale network having multiple subnets.

FIG. 3 is a schematic of a heterogeneous Metropolitan Area Network.

FIG. 4 is a network configuration having a mobile node, home agent, and foreign agent in both the home and foreign networks.

FIG. 5 is a network schematic illustrating how the home agent and foreign agent service a mobile node in a foreign network.

FIG. 6 illustrates a wireless communication network integrating a mobile node proxy in a base station that communicates with a mobile node.

### DETAILED DESCRIPTION

An improved method and system is disclosed that provides a proxy service from a network management device for each mobile node so that the mobile node can connect to any network with case.

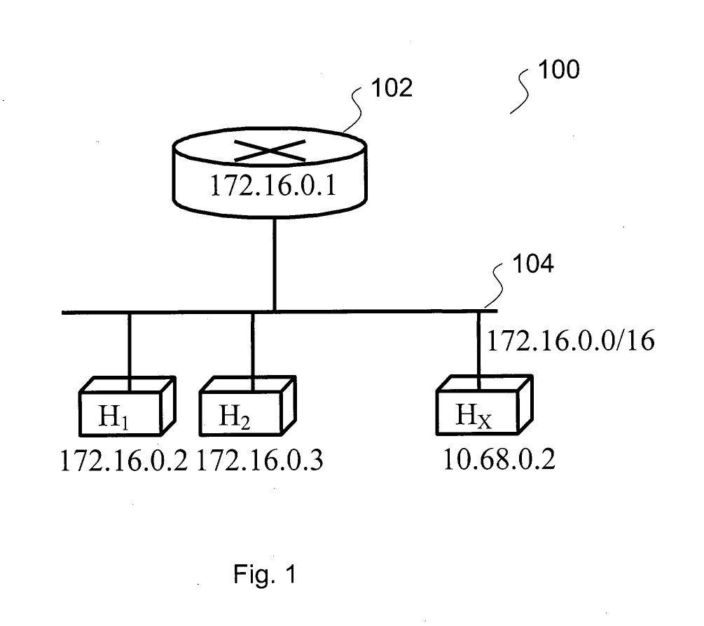

FIG. 1 illustrates a sample schematic for a communication network 100 in which a host Hₓ represents a mobile node with a topologically incorrect address, in this case, 10.68.0.2 in a foreign network wherein the IP addresses are 172.16.0.0-16. This network 100, although foreign to Hx, is the home network for mobile nodes H1 and H2 which have their IP addresses 172.16.0.2 and 172.16.0.3 respectively. These mobile nodes all connect to a router/hub 102 which has its own IP address of 172.16.0.1. The connection point 104 through which the mobile computing device Hx connects to the hub 102 is referred to as a point-of-attachment and is a shared connection point to all hosts on this network, e.g. H1, H2, and Hx.

Since the IP based datagram routing is made possible by a hierarchical topology of destination addresses, for a packet to traverse the Internet from one location to another, a series of routers between two end hosts may not know specific routing related information about these hosts if they belong to different networks. But, they are aware of the hierarchy or grouping information about the groupings of computers into subnetworks, groupings of subnets into networks, groupings of networks into supernets, and so forth. The routing decisions are then based upon hierarchal and topological knowledge of such groupings by using appropriate routing protocols. In order for the routers to deliver the packets to these two hosts on the opposite sides of the communication route, the corresponding hosts must belong to the correct hierarchal groupings.

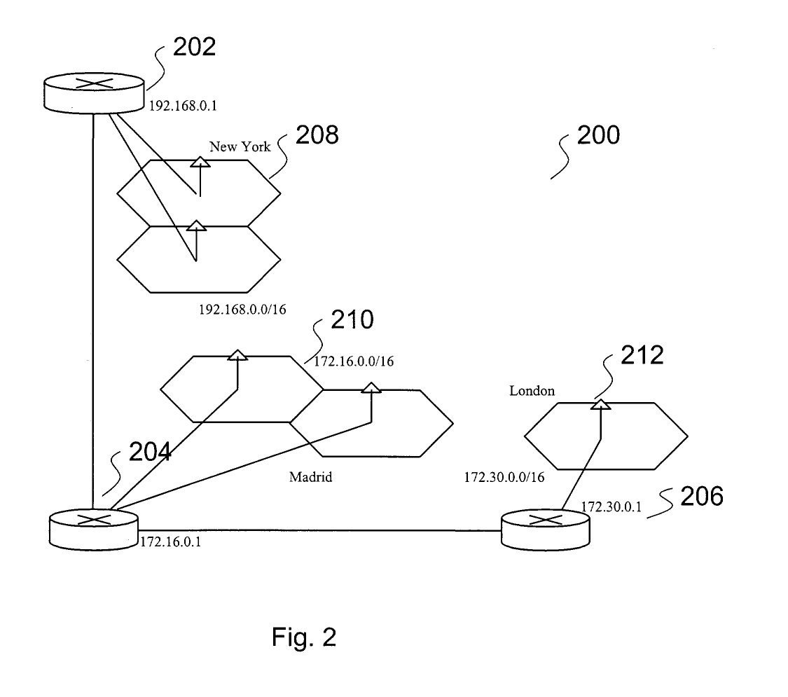

FIG. 2 illustrates another schematic of a large scale network 200 having multiple subnets for handling the routing of packets therein. The routers 202, 204, and 206 are responsible for routing packets for the subnets 208, 210, and 212. If a user or, more accurately, a host used by the user, belongs to the subnet 202, it must use an IP address of the subnet 202. Otherwise, if the host of the subnet 202 uses an IP address belonging to another subnet, e.g., the subnet 212, the router 206 of that subnet and other intervening router would forward any incoming datagrams destined to the host to the subnet 212 and find no recipient there. For example, if a laptop is taken from Madrid on subnet 210 to New York on subnet 208 and retains the same Madrid based IP address of its home network 210, for any incoming datagrams, the involved routers continue to forward datagrams to Madrid, as the laptop is actually physically detached from the home network in Madrid, and the communication is therefore disrupted on this laptop.

Although the user of the laptop can obtain a New York based IP address from the foreign network 208 that it is associated with, such nomadic support may only accommodate limited travel needs such as retrieving email from the home office, it does not accommodate more demanding or complicated applications. For instance, the traveling user may require services to support a remote database server on his host (e.g., his laptop) that his colleagues in the home office must always reach. In short, if an application requires a network layer constant address user, a host needs to have the ability to change its subnet point-of-attachment without losing its ability to communicate using the constant IP address in order to provide seamless support for higher layer session and application protocols throughout the mobile activities.

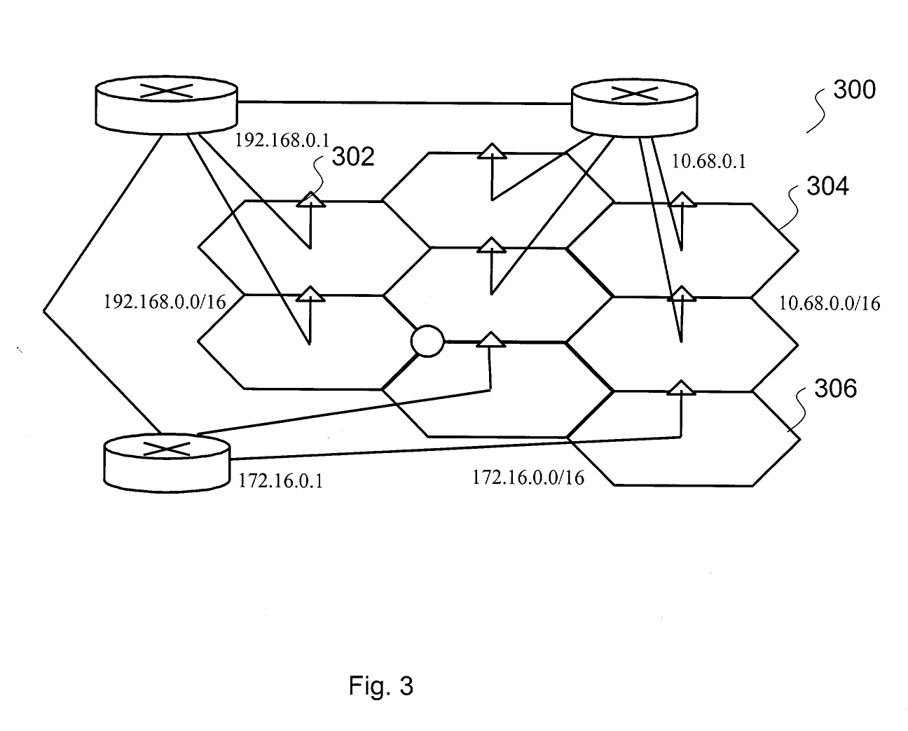

FIG. 3 is a schematic of a heterogeneous Metropolitan Area Network 300. As it is well understood that wireless communication networks may have bordering cells. As shown, a first subnet 302 may have a few cells bordering on cells of other subnets such as subnets 304 and 306. The cells in the first subnet 302 use IP addresses of 192.168.0.0-16, and the cells in the second subnet 304 use the IP addresses of 10.68.0.0-16, while, similarly, the cells in the third subnet 304 use the IP addresses of 172.68.0.0-16. As shown, the cells of different networks may have boundaries connecting therebetween. Depending on a specific network operator's design, such boundaries can be as pronounced as a separate boundary on every cell boundary, or as lax as a single boundary on the edge of the coverage area of the entire network. When a mobile user travels through a cell or subnet boundary to get into a cell of another subnet, network layer mobility may be required by the user. That is, the user may switch subnet point-of-attachment with or without any conscious knowledge of the switch device of the network. Unconscious mobility can occur as a result of many normal wireless network behaviors including, but not limited to, cell breathing, fading, or network administration. When switching between subnets, the mobile users may demand true network layer mobility without worrying about the effect of subnet migration. Moreover, some users may wish to maintain a constant network address.

The Mobile IP is relatively new but a well accepted standard communication protocol in the industry. In essence, the Mobile IP includes elements or processes such as Agent Discovery, Registration, Routing, and Security. Three architectural entities, mobile node, home agent, and foreign agent, are introduced according to the Mobile IP. The term mobile node refers to an end user's host computing platform (or “host”), such as a mobile PC or any other handheld device, etc. It is understood that the host/computing platform may require a semi-permanent Home Address (HoA) used to communicate with all any other hosts in the Internet because the HoA is the identifier for the mobile node for receiving packets. When the end user leaves his home network, and connects back through a point-of-attachment to a network or a subnet that is foreign to his home network, the communication data packets need to reach this HoA in order to communicate with the mobile node. In essence, regardless of the current point-of-attachment the mobile node uses, the HoA is used continuously for Mobile IP enabled services.

In order to support the mobile node to move around different subnets or networks without being troubled by the difference between these networks, one or more mobility agents are involved. While typically found in internetworking routers, mobility agents can actually be on any host connected to the communication networks. These agents can be largely categorized as foreign agents and home agents.

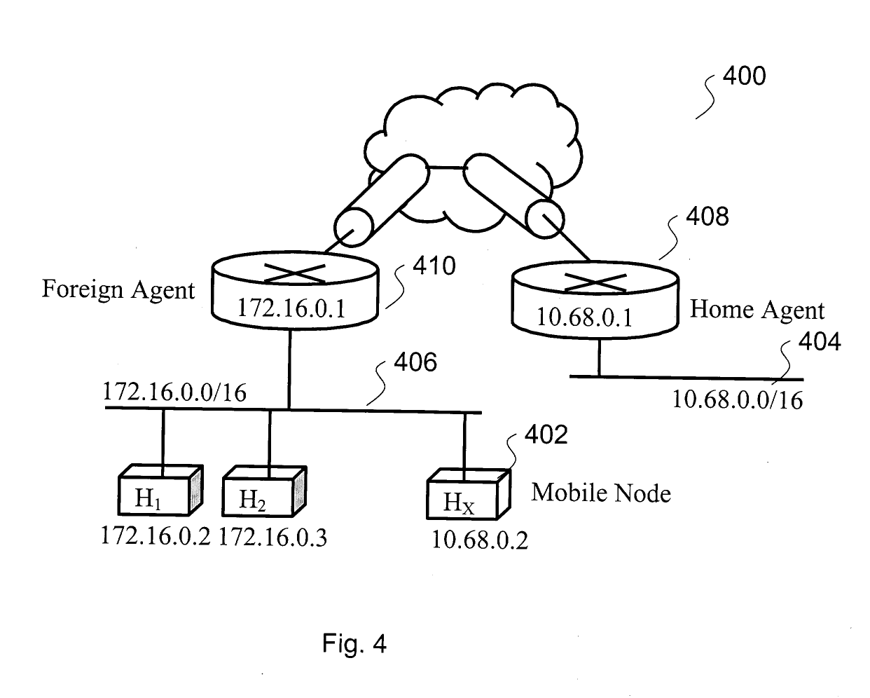

FIG. 4 depicts an example for a network arrangement 400 among the mobile node, home agent, and foreign agent in both the home and foreign networks. Whether a mobile agent is a foreign agent or a home agent, it is all relative to a particular mobile node in terms of which network it is connected to. For example, when a mobile node is connected to a foreign network, which is not its home network, a foreign agent provides mobile services to the mobile node when the mobile node's point-of-attachment is directly connected to the foreign network. On the other hand, consistent with this definition, the home agent is the one that resides on the home network of the mobile node which provides services when the mobile node is connected therewith. Therefore, when the mobile node is within the home network or when it's point-of-attachment is on the home network, the HoA of the mobile node clearly belongs to the home network conforming to its hierarchy, or “topologically correct,” and the home agent simply provides “pass-through” services to the mobile node. In FIG. 4, when the mobile node Hx (402) that has an HoA of 10.68.0.2 moves away from its home network 404 and connects to another network 406, it is in a foreign network. The foreign network uses IP addresses of 172.16.0.2-16. It is noticed that the mobile node Hx's home network 404 is serviced by a home agent 408 while a foreign agent 410 services Hx when it is in the foreign network 406.

It is possible for a home agent to exist on a virtual home network, which is a network with no physical media for the mobile node to be attached to. This means that there is no physical home network a mobile node belongs to, and the mobile node is always physically attached to a foreign network while seemingly associated to a virtual home network. When the mobile node moves to a foreign network, the home agent from the virtual network helps to provide mobility services to the mobile node remotely.

It is also possible for a single mobile agent to service a mobile node of the same home network as well as a mobile node coming from a foreign network simultaneously. It is understood that that particular mobility agent is the foreign agent to the “visiting” mobile node and the home agent to the “home” mobile agent. For example, the mobility agent 410 is the foreign agent to Hx, but is the home agent to others in its own network. As such, it can provide foreign agent services to some mobile nodes when providing home agent services for other mobile nodes simultaneously.

According to the Mobile IP, the mobile node is in charge of its own destiny while moving around different networks/subnets using the Mobile IP. Mobility agents simply services the communication needs of the mobile nodes. When a mobile node connects through a point-of-attachment, in an agent discovery and move detection process, it determines the topological correctness of its current point-of-attachment, and to find all the mobility agents that currently service this point-of-attachment. On the other hand, the mobility agent on a network broadcasts an advertisement message periodically to receiving information about entities such as the connected mobile nodes on the network. This advertisement message informs potential mobile nodes the profile information about this particular agent. Alternatively, a mobile node can actively solicit this advertisement message if the periodic broadcast is not frequent enough to meet the needs of the mobile node.

Having received advertisement messages from one or more mobility agents, the mobile node evaluates the contents of the message to determine if it is attached to its home or foreign network. Moreover, it checks the capabilities of the mobility agent to see whether the mobility agent is qualified to service its operation. If the mobile node discovers that it is indeed connected to a foreign network, a topologically correct care-of-address (CoA) is needed to be used while it remains on the foreign network. The address of the identified foreign agent is most likely to be the CoA used.

Under the framework of the Mobile IP, a mobile node is permitted to serve as its own foreign agent when the authorization policies at the foreign network allow it to do so. In this case, the care-of-address is a co-located care-of-address and the agent discovery process is not performed while the mobile node is away from the home network.

After having found the most suitable agent for the current point-of-attachment, the mobile node informs and requests services from both its foreign agent and home agent when it is logged on a foreign network. In the situation that the mobile node actually connects back to the home network after moving away for a while, the mobile node sets to disable foreign network mobility services from its home agent. All these can be completed through a registration with the home agent, and optionally with the foreign agent too. When in a foreign network, at a minimum, the registration instructs the home agent the current care-of-address to forward datagrams destined to the mobile node (that has now moved away from the home network).

Because this registration process effectively updates the routing mechanism of datagrams dynamically, it may need to be authenticated for security reasons so that no false routing is allowed. This assures that the communication sessions conducted between the mobile node and the home agent are protected. The Mobile IP provides for strong authentication protection using cryptography. For example, every registration may include authentication material so that a home agent sharing a security association can guarantee that it originates from the mobile node without repudiation. However, this may require predetermined security mechanisms such as the distribution of security keys amongst those entities sharing a security association. In addition to the functions described above, the registration process is also used to negotiate various options such as time-to-live, tunnel types, broadcast handling, etc., for communication purposes. Up till now, the processes that the mobile node has gone through may be referred to collectively as a control signaling process.

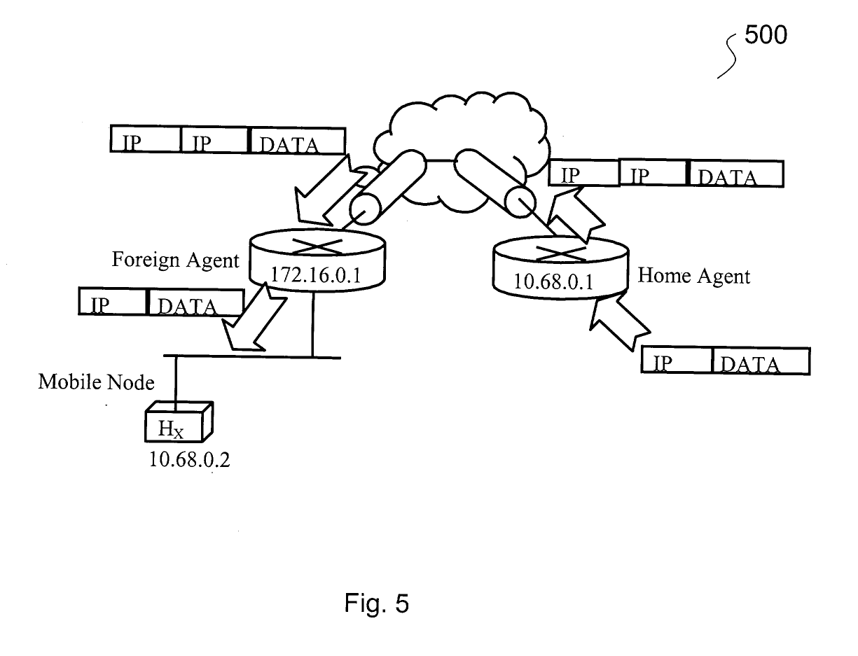

FIG. 5 is a network schematic 500 illustrating how the home agent and foreign agent service a mobile node in a foreign network. Having completed the control signaling processes, the Mobile IP protocol utilizes the registered care-of-address to build a tunnel through the Internet for datagram delivery. When the associated home agent detects and intercepts all datagrams targeted for the moved-away mobile node, it forwards them through the tunnel to the care-of-address, which is associated with the foreign agent that the mobile node has identified. There may be various ways to create the tunnel as it is known in the industry, and in the simplest form, the tunnel encapsulates the original IP datagram as the payload of an outer IP datagram. The outer datagram delivers its payload to the identified care-of-address which is associated with the foreign agent. Once delivered, the original IP datagram is extracted by the foreign agent and delivered to the mobile node for processing.

In some cases, the mobile node needs to send out datagrams through its home network. Its outbound datagrams are intercepted by the foreign-agent and tunneled back to the home agent at the home network. When the home agent gets the tunneled datagrams, it de-tunnels the datagrams and forwards them into whatever the destination on the Internet that is specified.

When the mobile node moves and connects to a network, conventionally the mobile node has to be equipped with certain mobile client software for communicating with the connected network. The mobile client software on the mobile node initiates the communication and configuration between the foreign and home networks. As such, communication overhead processes such as the control signaling process as described above are carried out directly between the mobile node and a network switching device such as the router.

In some product implementations of the mobile node, instead of having all functions provided by a single device (e.g., a laptop having a built-in wireless modem), an independent wireless communication access device such as a wireless modem or other similar device is used in conjunction with a computing device such as a laptop for providing mobile communication accesses. In such a case, the wireless communication access device can have all necessary software or hardware installed therein to create and maintain a mobile node proxy to handle the control signaling process so as to relieve the computing device from participating in the tedious control signaling process. The benefit of this implementation may be significant in that any node such as a laptop, which may not have wireless connection capability, can become a true mobile node through the use of the wireless communication access device which has the mobile proxy on it for communication needs.

To relieve the mobile node from the burden of having mobile client software and to relieve it from participating in all overhead communication processes, a mobile node proxy can be built in a fixed telecommunication device such as a base station that communicates to the mobile node through a wireline or wireless communication channel. The mobile node proxy becomes an extension of the home network so that the mobile node can connect to the network with any mobile client software. Because the proxy provides the appearance of an extension of the home network, the mobile node views that it is always connected to its home network. Once the mobile node proxy is built, multiple hosts or mobile nodes can be linked thereto.

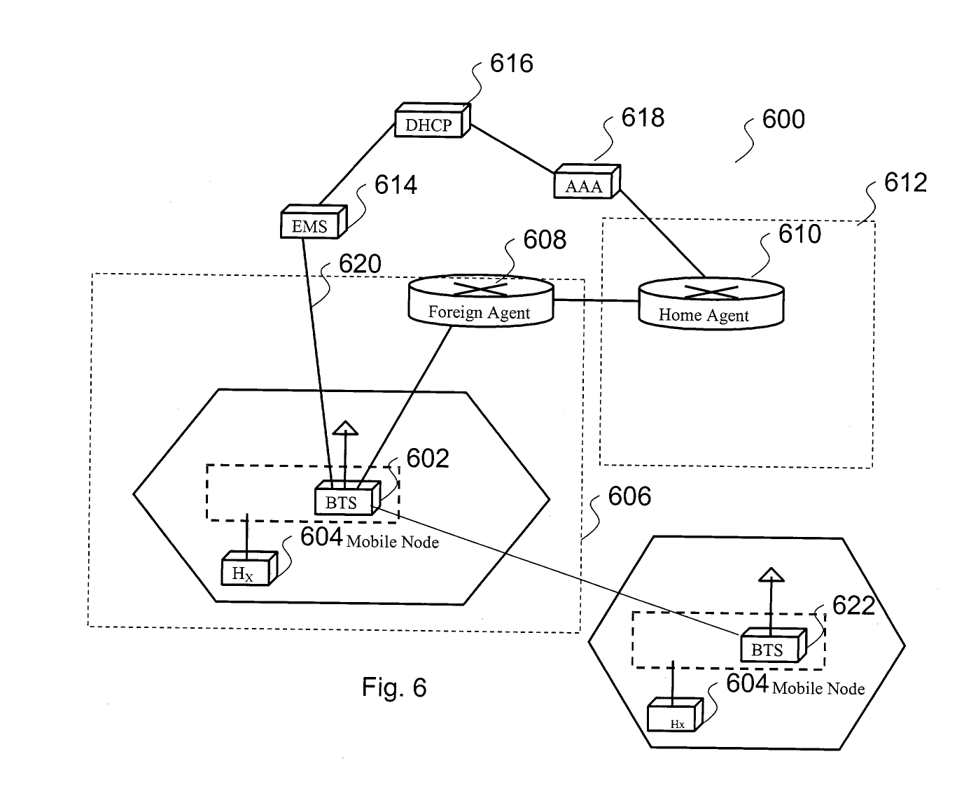

FIG. 6 illustrates a wireless communication network 600 integrating a mobile node proxy in a base station 602 that communicates with a mobile node 604. The base station 602 may belong to a foreign network 606 and connect to a foreign agent 608 of the mobile node 604. The foreign agent 608 connects further back to a home agent 610 of the mobile node in its home network 612. Also shown in FIG. 6, the base station is connected to Element Management System (EMS) 614, Dynamic Host Configuration Protocol Server (DHCP) 616, and Authentication-Authorization-Accounting server (AAA) 618 through wirelines. Further, the base station can detect all mobility agents dynamically using the standard Mobile IP agent discovery process. The base station 602 may provide a mobile node proxy service for the mobile node so that the base station becomes an active component in operating agent discovery and registration through wireline connections while using minimal wireless overhead messaging with the mobile node. It is understood that the foreign agent 608 may reside on a servicing gateway router for the subnet 606.

The base station can automatically handle sharing and transferring of registration related information with other base stations as the user moves around in the wireless communication network. The mobile node proxy provided by the base station monitors each point-of-attachment of the related network/subnet at the network layer level and provides standard Mobile IP registration service with the home agent as needed when the mobile node crosses a network/subnet boundary. For example, after the base station 602 creates a mobile node proxy thereon for the mobile node 604, when the mobile node 604 enters the boundary of the subnet and connects to the base station through a point-of-attachment, the mobile node proxy acquires the HoA of the mobile node in the home network through the home agent or another base station in the home network of the mobile node pretending that the mobile node proxy is the mobile node.

The mobile node proxy can obtain the HoA through various ways. For example, through static provision, through intercepting the route between the mobile node and the DHCP server 620, or through continual contact with a central repository will all allow the mobile node proxy to obtain the HoA of the mobile node. As such, the mobile node proxy has, in fact, become an extension of the home network for the visiting mobile node. Once the base station 602 has sufficient information for conducting and completing the control signaling process, the mobile node is then connected through the mobile node proxy in the base station 602, the foreign agent of the foreign network, and back to the home network. When this configuration is complete, the mobile node functionality is in fact distributed throughout the network on base stations or other gateway devices servicing subnets' point-of-attachments through proxies or proxy agents.

For the base stations to share the HoA of multiple mobile nodes, there are various possible mechanism. For example, the addresses of the mobile nodes can be stored in a centralized repository such as a dedicated DHCP server. A mobile node registers its HoA in the centralized repository by a identifier associated with the interface used to connect to the base station, e.g. MAC address, an Electronic ID of a wireless modem, or some other link layer identifier. When a mobile node proxy is generated for a specific mobile node, the base station will check with this centralized repository to obtain the HoA using the identifier of the interface used to connect to the base station. The HoA information can be updated periodically or dynamically (e.g., when a new DHCP request is detected). This mechanism simplified the administration of the address information.

As an alternative, if each base station informs other base stations such as the base station 622 in FIG. 6 about what mobile nodes they currently service, direct communications between two base stations can be carried out to inform each other the HoA of the moving mobile node. In addition, when the mobile node connects to a first base station, the address information of the base station can also be stored in the mobile node. When the mobile node moves to the foreign network, and connects to a second base station, it will indicate to the second base station which the contact information about the first base station. As such, the second base station can immediately communicate to the first base station and complete the control signaling process.

Another alternative, is for each mobile node to retain information about their HoA and inform the base station when making contact with that base station. This information is provided to the new base station and utilized by a mobile node proxy instance created on that base station for this mobile node.

Consideration may be taken from a provisioning perspective in determining an appropriate home agent to be assigned to a mobile node. In one example, if a mobility agent is used during an initial commissioning through the mobile node's point-of-attachment, this mobility agent would be an appropriate home agent. The base station also helps to facilitate the determination of this initial commissioning point-of-attachment for backend equipment through the Circuit ID Relay Information Sub-option of the DHCP transaction. This requires the DHCP server used for unauthenticated users to interact with the provisioning system used to provide information about the home agent to the mobile node.

In addition, security key distribution modules can also be provided for enhancing the security concerns. During initial provisioning of a user's host and subsequently authorized HoA, a pseudo-random key should be generated and distributed to the host. Simultaneously, that same key should be disseminated to the home agent using an equivalent simple network management protocol (SNMP) transaction or to a centralized AAA Server. Further, many mobile agents may support using the Remote Authentication Dial In User Service (RADIUS), IPsec Key Exchange (IKE), DIAMETER, or other key distribution protocols for dynamically retrieving the security association from an AAA server on-demand.

The above disclosure provides several different embodiments, or examples, for implementing different features of the disclosure. Also, specific examples of components, and processes are described to help clarify the disclosure. These are, of course, merely examples and are not intended to limit the disclosure from that described in the claims.

While the disclosure has been particularly shown and described with reference to the preferred embodiment thereof, it will be understood by those skilled in the art that various changes in form and detail may be made therein without departing from the spirit and scope of the disclosure.

What is claimed is:

1. A method for servicing a mobile node using Mobile Internet Protocol (Mobile IP) when it joins a foreign network, the mobile node intending to connect to a home network through the foreign network, the method comprising:
detecting the mobile node when it connects to a first point-of-attachment in the foreign network;
establishing a first mobile node proxy communicating with the foreign network;
acquiring a first IP address associated with the mobile node in the home network through the first mobile node proxy pretending that the first mobile node proxy is the mobile node;
acquiring a second IP address of a first mobile agent associated with the mobile node on the home network through the first mobile node proxy pretending that the first mobile node proxy is the mobile node; and
establishing a first communication route between the first mobile node proxy and the first mobile agent on the home network through the foreign network using the acquired first and second IP addresses,
wherein the first mobile node proxy shields the mobile node from conducting at least one control signaling process conforming to the Mobile IP when the mobile node joins the foreign network so as to eliminate the need for the mobile node to consume resources for participating in the control signaling process.

2. The method of claim 1 further comprising acquiring security information associated with the mobile node and its home network through the first mobile node proxy so that communication sessions conducted can be protected with a predetermined security mechanism.

3. The method of claim 1 wherein the first mobile node proxy is built on a communication management device of the foreign network.

4. The method of claim 1 wherein the first mobile node proxy is built on a wireless communication access device working in conjunction with the mobile node.

5. The method of claim 1 wherein the acquiring a first IP address further includes retrieving the IP address from a central repository in which the mobile node has registered the IP address.

6. The method of claim 5 wherein the acquiring a first IP address further includes obtaining IP address using a dynamic host configuration protocol.

7. The method of claim 1 wherein the acquiring a first IP address further includes obtaining IP address from the mobile node.

8. The method of claim 1 further comprising servicing the mobile node by the first mobile node proxy when it moves to a second point-of-attachment in the foreign network.

9. The method of claim 1 further comprising:
establishing a second mobile node proxy when the mobile node moves to a second point-of-attachment;
sharing the first and second IP addresses acquired by the first mobile node proxy with the second mobile node proxy; and
establishing a second communication route between the mobile node and the home network through the second mobile node proxy.

10. The method of claim 9 wherein the second mobile node proxy is built on a communication management device of the foreign network.

11. The method of claim 10 wherein the second mobile node proxy is built on a wireless communication access device working in conjunction with the mobile node at the second point-of-attachment.

12. The method of claim 9 wherein the sharing further comprising obtaining the first and second IP addresses from a first communication management device by a second communication management device of the foreign network when the first and second mobile node proxies are built on the first and second communication management devices respectively.

13. A method for servicing a mobile node using Mobile Internet Protocol (Mobile IP) when it joins a first foreign network, the mobile node intending to connect to a home network through the first foreign network, the method comprising:
detecting the mobile node when it connects to a first point-of-attachment in the first foreign network;
establishing a first mobile node proxy on a first base station of the first foreign network servicing the first point-of-attachment;
acquiring a home network based IP address associated with the mobile node from the home network through the first mobile node proxy pretending that the first mobile node proxy is the mobile node;
conducting at least one control signaling process by the mobile node proxy for establishing a first communication route between the mobile node and the home network through the first mobile node proxy using the acquired IP address,
wherein the mobile node does not consume communication resources for participating in the control signaling process.

14. The method of claim 1 further comprising servicing the mobile node when it moves to a second point-of-attachment.

15. The method of claim 14 wherein the second point-of-attachment is in the first foreign network.

16. The method of claim 15 further comprising:
establishing a second mobile node proxy for the mobile node moving to the second point-of-attachment;
sharing the IP address acquired by the first mobile node proxy with the second mobile node proxy; and
establishing a second communication route between the mobile node and the home network through the second mobile node proxy.

17. The method of claim 14 wherein the second point-of-attachment is in a second foreign network.

18. The method of claim 17 further comprising:
establishing a second mobile node proxy for the mobile node in a second base station located in the second foreign network;
sharing the IP address acquired by the first mobile node proxy with the second mobile node proxy; and
establishing a second communication route between the mobile node and the home network through the second mobile node proxy.

19. The method of claim 13 wherein the acquiring further includes retrieving the IP address from a central repository in which the mobile node has registered the IP address therein.

20. The method of claim 13 wherein the acquiring further includes obtaining IP address from the mobile node.

21. The method of claim 13 further comprising conveying datagrams between the mobile node and a home agent of its home network through the first mobile node proxy and a foreign agent of the first foreign network using packet tunneling.

22. The method of claim 21 wherein the foreign agent is on the first base station.

23. A system for servicing a mobile node using Mobile Internet Protocol (Mobile IP) when it joins a foreign network, the mobile node intending to connect to a home network through the foreign network, the system comprising:
a foreign agent detecting the mobile node when it connects to a first point-of-attachment in the foreign network;
a first mobile node proxy communicating with the foreign network;
a home agent servicing the mobile node from the home network,
wherein an IP address of the mobile node in the home network is acquired by the first mobile node proxy pretending that the first mobile node proxy is the mobile node, and an IP address of the home agent is acquired through the first mobile node proxy pretending that the first mobile node proxy is the mobile node,
wherein a first communication route is established between the first mobile node proxy and the home agent through the foreign agent using the acquired IP addresses, and
wherein the first mobile node proxy shields the mobile node from conducting at least one control signaling process conforming to the Mobile IP when the mobile node joins the foreign network so as to eliminate the need for the mobile node to consume resources for participating in the control signaling process.

24. The system of claim 23 further comprising means for acquiring security information associated with the mobile node and its home network through the first mobile node proxy so that communication sessions conducted can be protected by a predetermined security mechanism.

25. The system of claim 23 further comprising a communication management device of the foreign network hosting the first mobile node proxy.

26. The system of claim 23 further comprising a wireless communication access device hosting the first mobile node proxy and working in conjunction with the mobile node.

27. The system of claim 23 further comprising means for retrieving the IP address of the mobile node from a central repository in which the mobile node has registered the IP address.

28. The system of claim 23 further comprising means for retrieving the IP address of the mobile node from the mobile node.

29. The system of claim 23 further comprising:
a second mobile node proxy established when the mobile node moves to a second point-of-attachment; and
means for sharing the first and second IP addresses acquired by the first mobile node proxy with the second mobile node proxy,
wherein a second communication route is established between the mobile node and the home network through the second mobile node proxy.

30. The system of claim 29 further comprising a communication management device of the foreign network hosting the second mobile node proxy.

31. The system of claim 29 further comprising a wireless communication access device hosting the second mobile node proxy and working in conjunction with the mobile node at the second point-of-attachment.

32. The system of claim 29 wherein the means for sharing further comprising means for obtaining the IP address of the home agent and the IP address of the mobile node from a first communication management device by a second communication management device of the foreign network when the first and second mobile node proxies are built on the first and second communication management devices respectively.
